(19) United States
(12) Patent Application Publication
(10) Pub. No.: US 2010/0071440 A1
(43) Pub. Date: Mar. 25, 2010

(54) PRESSURE SENSOR WITH INTEGRATED TEST DEVICE AND METHOD FOR TESTING SUCH A SENSOR

(76) Inventor: Josef Glaser, Graz (AT)

Correspondence Address: DORITY & MANNING, P.A., POST OFFICE BOX 1449, GREENVILLE, SC, 29602-1449, US

(21) Appl. No.: 12/447,484

(22) PCT Filed: Nov. 12, 2007
(86) PCT No.: PCT/CH07/00556

§ 371 Date: Apr. 28, 2009

(30) Foreign Application Priority Data
Nov. 10, 2006 (AT) A 1865/2006

(51) Int. Cl. G01L 27/00

(52) U.S. Cl. 73/1.57

(57) ABSTRACT

The invention relates to a pressure sensor comprising a housing, a membrane and at least one measuring element for measuring a pressure acting upon the membrane from outside the housing. The pressure sensor also comprises a channel system, inside the housing, which system can be filled with a test medium. The channel system comprises at least one pressure chamber. The pressure chamber is arranged in such a manner that a defined test pressure applied therein produces a known pressure change in the measuring element.

### CROSS-REFERENCE TO RELATED APPLICATIONS

This application claims priority to International Application Serial No. PCT/CH2007/000556 filed Nov. 12, 2007, which claims priority to Austrian Application No. A 1865/2006 filed Nov. 10, 2006.

### TECHNICAL FIELD

The invention relates to a pressure sensor, comprising a housing, a membrane, and at least one measuring element for measuring a pressure acting upon the membrane from the outside of the housing, further comprising a channel system within the housing, which system can be filled with a test medium. Furthermore, the present invention relates to a method for testing the quality and for calibrating such a sensor.

### BACKGROUND

Certain pressure sensors have to measure the pressure very reliably and exactly over a long period of time. In particular, this relates to pressure sensors which are incorporated into a component, e.g. into an engine or a machine part, over a long time and which constantly monitor processes.

Since sensors may change in the course of time, the function of each of said sensors has to be tested on suitable calibration devices in a disassembled state, or it has to be possible by using valves disposed upstream of the sensor to switch from a measuring pressure to a test pressure. In each ease, a sensor is put under compressive stress for the calibration always in the same manner.

For applying such test pressures, valves are required which increase the dead volume upstream of the sensor, enlarge the feed line and thus cause strong resonance vibrations and pipe resonances, in particular with pressure measurements in gases. The reliable function of such valves can hardly be assured with hot and dirty processes, and the long inlet channels will be frequently obstructed by dirt deposits.

### OBJECTS AND SUMMARY OF THE INVENTION

The object of the present invention is to provide a pressure sensor which may be tested and/or calibrated, without valves which are susceptible to faults being mounted upstream of the sensor and if possible without large dead spaces or long channels between sensor and pressure measuring chamber. Furthermore, a method shall be provided for testing such a sensor, wherein the test has to be performed in the incorporated state, without the membrane having to be accessible from the outside.

The object is solved by the fact that the pressure sensor has an integrated testing apparatus, by means of which a defined test pressure Dp may be generated in a pressure chamber in the sensor housing, which test pressure shall produce a known pressure change D1 in the measuring element. By the comparison of an actually occurring pressure change D2 with the expected known pressure change D1, the quality of the pressure sensor may be deduced, which pressure may be correspondingly calibrated.

In particular, this test method is also possible with an ongoing pressure measurement.

### BRIEF DESCRIPTION OF THE DRAWINGS

In the following, the invention is explained in more detail with respect to the drawings, which show:

FIG. 1 a schematic illustration in a cross-sectional view of a pressure sensor according to the present invention with a pressure chamber and a piezoelectric or piezoresistive measuring element;

FIG. 2 a schematic illustration in a cross-sectional view of a pressure sensor according to the present invention in an alternative embodiment;

FIG. 3 a schematic illustration in a cross-sectional view of a pressure sensor according to the present invention in another alternative embodiment;

FIG. 4 an illustration according to FIG. 3, however with a capacitive, optical or inductive measuring element;

FIG. 5 an illustration according to FIG. 3, however, with a resistance strain gauge as a measuring element.

The reference symbols each are the same in all figures.

### DETAILED DESCRIPTION OF EXEMPLARY EMBODIMENTS

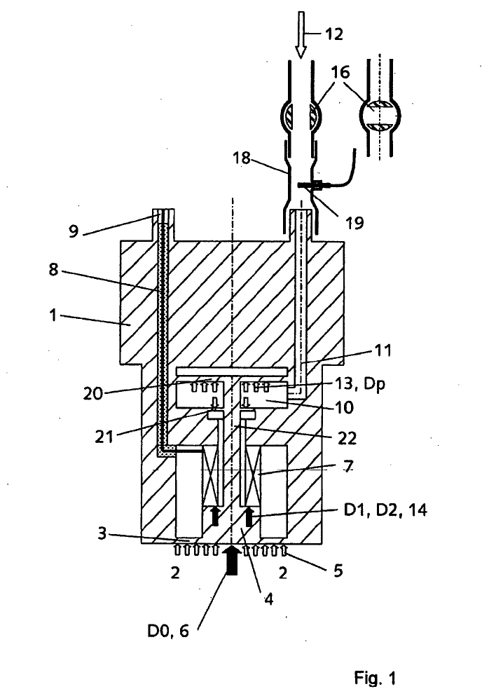

FIG. 1 shows a pressure sensor in a cross-sectional view with a housing 1, a membrane 3 as well as with a measuring element 7 for measuring a pressure 5 acting onto the membrane 3 from a pressure chamber 2 outside of the housing 1. Said pressure 5 acts with a resulting force 6 onto a pressure plate 4, which again applies a force onto the measuring element 7. From this measuring element 7, a measuring line 8 leads to a connecting terminal 9 on the rear side for a connection for transmitting the measurement signals.

In this embodiment, the measuring element 7 is divided or hollow-cylindrical, and the pressure plate 4 exhibits an extension 22, which extends behind the measuring element 7, so that both a separation membrane 21 and a preloading element 20 which are both mounted at the extension 22 may be arranged behind the measuring element 7.

Further, the pressure sensor comprises a feed line 11, by means of which a test medium 12 can advance to a pressure chamber 10. A sensor 19 within line 11 can determine a test pressure Dp. Line 11 and pressure chamber 10 together form a channel system. At line 11 an elastic line 18 may be mounted at the outside of the housing 1, for example as an intermediate part, which simplifies the handling. A valve 16 at line 11 allows the line 11 to be closed.

Thus, a test pressure Dp applied in line 11 may be maintained, which acts in the pressure chamber 10, represented with arrows 13. Said pressure 13 acts through the extension of the pressure plate 22 as a resulting test pressure 14 onto the measuring element 7 from the inside thereof, i.e. in the same direction as the total pressure 6 from the pressure chamber 2.

In this embodiment, the pressure chamber 10 is arranged between the separation membrane 21 and the preloading element 20, which is also a membrane.

The pressure chamber 10 is arranged in the housing in such a manner, that the defined test pressure Dp applied therein generates a known pressure change D1 in the measuring element 7. This pressure change D1 refers to a pressure which at the most acts on the outside of the membrane, and which is also determined shortly before the application of the test pressure.

A test of the sensor at a later time may be performed in an incorporated state, even during a measurement. For this purpose, the predetermined test pressure Dp is applied to the test medium 12 in the channel system 11, 10, and the pressure change D2 generated by the test pressure Dp, which is determined at the measuring element 7, is compared with the known pressure change D1 to be expected, in the measuring element 7 (D1-D2). Thus, with deviations from the expected value D1, new calibration data may be determined and entered into corresponding evaluation devices. The pressure changes each relate to the pressure D0 from the pressure chamber 2 which is prevailing at the time of calibration.

The temperature of the test medium 12 may be selected within wide limits. The valve 16, which is necessary also here to apply and subsequently also to cancel again the predetermined test pressure, works under substantially more favourable conditions and is further more reliable than under those of the applications mentioned in the state of the art. Furthermore, the test pressure is applied only slowly, so that line 11 may be long and thus is uncoupled in a mechanical and thermal manner. This is necessary, if the sensor is highly stressed by vibrations. Due to this significantly minor requirement, the valve 16 which has been uncoupled in such a manner may be produced in a substantially more inexpensive way.

The minimum equipment for the use of a pressure sensor which may be calibrated from the back side covers at least one feed line, which can carry the test medium to the sensor, and a valve 16, which is connected to a line 11, which carries the test medium to the pressure chamber 10. Piezoelectric sensors, which are not able to measure in a static manner, are calibrated by means of pressure jumps. Therefore, a rapidly opening valve 16 is necessary, which discharges only the pressure chamber 10 if possible via a short line 11.

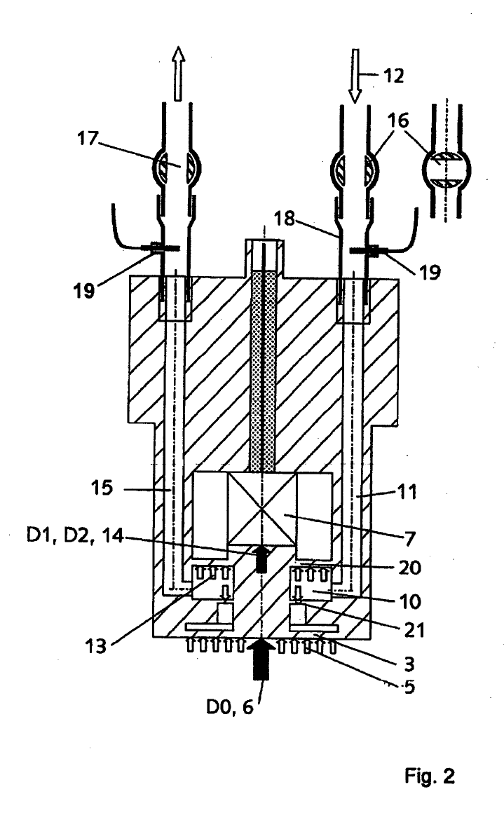

FIG. 2 shows a further sensor according to the present invention with a measuring element 7, which supports the compression forces onto the membrane 3. With respect to the pressure measuring function this variant is practically identical to the variant represented in FIG. 1. A plate shaped preloading element 20 is also used in this case. Between membrane 3 and preloading element 20 a separation membrane 21 is arranged. The line 11 leads into the pressure chamber 10 between preloading element 20 and separation membrane 21. In this case again, the inner calibration pressure 13 onto the preloading element 20 and the separation membrane 21 results in a resulting force 14 onto the measuring element 7, which again exhibits the same direction as the force 6 or the pressure D0 from the outer measuring pressure 5. Said same direction of the calibration forces may be a critical advantage with non-linearities of the measuring element. In contrast to FIG. 1, the pressure chamber 10 as well as the preloading element 20 and the separation membrane 21 are here disposed between membrane 3 and measuring element 7.

Moreover, in this FIG. 2 embodiment two lines 11, 15 for filling 11 and discharging 15 are shown to be attached at the pressure chamber 10. Correspondingly, two valves 16, 17 are mounted at both lines 11, 15. If filling and discharging of the sensor is accomplished through one channel 11, 15 each, then this arrangement may be used for auxiliary functions.

When applying the test pressure Dp, the valve 17 is closed, when relieving the test pressure Dp or switching to another test pressure, for example to external pressure, valve 16 will be closed and valve 17 will be opened.

For example, a continuous flow through the sensor enables a heat input into or a heat dissipation from the sensor and thereby causes an expansion of the thermal functional area of the sensor.

If the temperatures in feed line 11 and discharge line 15 at the sensors 19 are measured, a measured variable for the heat load of the sensor and thus also for the structure, in which the sensor is incorporated, is obtained.

The measurement of the flow rate or the composition of the gas flowing off enables a continuous tightness test of the sensor. Chemical sensors or flow sensors also reveal a leakage of the sensor.

The inner calibration may be used for monitoring the sensor in the incorporated state, without disturbing the outside pressure measurement.

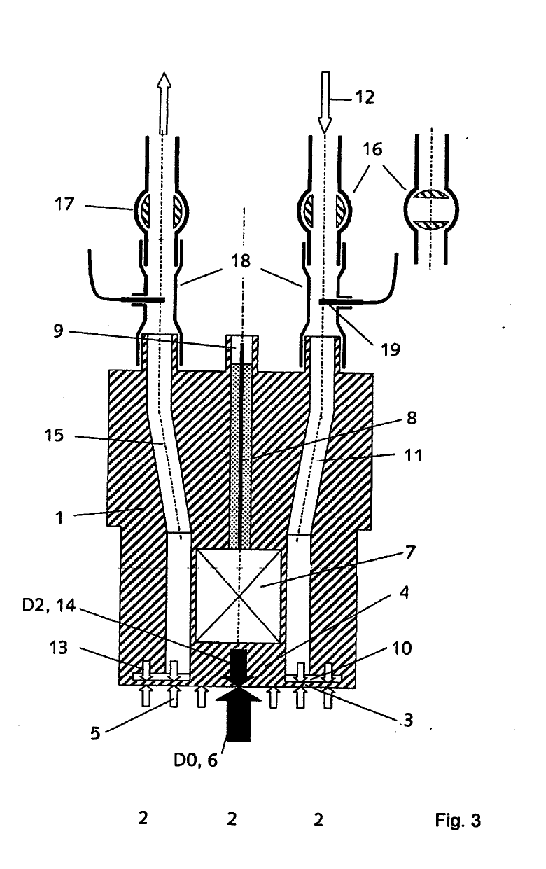

FIG. 3 shows a sensor similar to those in FIGS. 1 and 2, however, the pressure chamber 10 is disposed immediately adjacent at the backside of the membrane 3. This sensor has a cylindrical preloading element.

In this embodiment, the test pressure 13 functions as a resulting force 14 represented here, and thus against the total force 6 applied from the pressure chamber 2. In this case, the measurement value detected by the measuring element 7 is reduced by a test pressure D2 (D0-D2).

Of course, the sensor according to FIG. 1 also may be equipped with two lines 11, 15 and the corresponding valves and thus it may possess the same advantages as described hereinabove. In exactly the same manner, the other sensors each can have only one line 11.

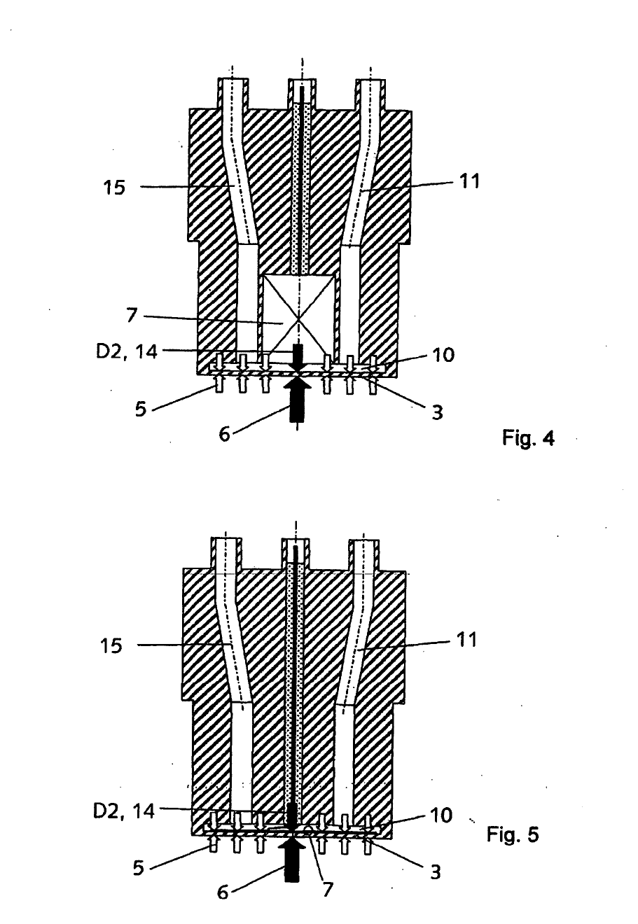

FIG. 4 shows a sensor in accordance with FIG. 3, wherein in this case the membrane 3 is not mechanically connected with the measuring element 7, but it supports the measuring pressure 5 only by its own stiffness and deforms under this measuring pressure. Therefore for example, the measuring element functions in a capacitive, inductive or optical manner.

In accordance to FIG. 4, FIG. 5 shows a sensor in which the measuring pressure is essentially supported at the membrane 3, however, in this case the tension or deformation is measured at the membrane surface itself, for example through resistance strain gauges 7.

### LIST OF REFERENCE SYMBOLS

1 housing
2 pressure chamber
3 membrane
4 pressure plate
5 pressure
6 total pressure
7 measuring element
8 measuring line
9 connecting terminal
10 pressure chamber
11 feed line
12 test medium
13 test pressure
14 resulting test pressure
15 line for discharging the test medium
16 valve
17 valve
18 elastic lines
19 sensor
20 preloading element
21 separation membrane
22 extension of the pressure plate
Dp defined test pressure
D0 pressure acting from the pressure chamber onto the membrane
D1 known (expected) pressure change in the measuring element, caused by a defined test pressure Dp applied in the pressure chamber
D2 actually measured pressure change in the measuring element, caused by a defined test pressure Dp applied in the pressure chamber
D1-D2 measure for the recalibration of the measuring element

1. A pressure sensor comprising a housing, a membrane as well as at least one measuring element for measuring a pressure acting onto the membrane from the outside of the housing, further comprising a channel system within the housing, the channel system being configured to be filled with a test medium, wherein the channel system at least defines a pressure chamber, which is arranged in such a manner that a defined test pressure applied therein generates a known pressure change in the measuring element.

2. A pressure sensor according to claim 1, wherein the measuring element is one of a piezoelectric measuring element, a piezoresistive measuring element, a capacitive measuring element, an optical measuring element or an inductive measuring element or a resistance strain gauge.

3. A pressure sensor according to claim 1, wherein the pressure chamber is arranged in the housing behind the measuring element with respect to the pressure direction (D0), wherein on both sides of the pressure chamber inner membranes abut to the pressure chamber in such a manner that a pressure applied in the pressure chamber generates a resulting pressure in the direction of the measuring element.

4. A pressure sensor according to claim 1, wherein the pressure chamber is arranged between the membrane and the measuring element, wherein on both sides of the pressure chamber with respect to the pressure direction inner membranes abut to the pressure chamber in such a manner, that a pressure applied in the pressure chamber generates a resulting pressure in the direction of the measuring element.

5. A pressure sensor according to claim 1, wherein the pressure chamber abuts to the membrane from within the housing in such a manner, that a pressure applied in the pressure chamber acts against a pressure acting onto the membrane from the outside of the housing.

6. A pressure sensor according to claim 1, wherein the channel system at least contains a first line and a second line for the discharge of the medium.

7. A pressure sensor according to claim 1, wherein the channel system at least includes one valve for opening and closing the channel system.

8. A pressure sensor according to claim 1, wherein the channel system at least contains one for measuring temperatures, pressures and/or flows in the channel system.

9. A method for testing the quality of a sensor according to claim 1, wherein at a known external pressure onto the membrane
a) the predetermined test pressure is applied to the test medium in the channel system,
b) the pressure change generated by the test pressure onto the measuring element is determined, and is compared with the expected, known pressure change in the measuring element.

10. A method according to claim 9, wherein subsequently calibration values of the pressure sensor are adapted due to the determined pressure difference between the pressure change generated by the test pressure onto the measuring element and the known pressure change in the measuring element.

11. A pressure sensor according to claim 1, wherein the channel system at least includes two valves for opening and closing the channel system.

12. A pressure sensor according to claim 1, wherein the channel system at least contains two sensors for measuring temperatures, pressures and/or flows in the channel system.
